(19) United States
(12) Patent Application Publication
(10) Pub. No.: US 2021/0406714 A1
(43) Pub. Date: Dec. 30, 2021

(54) Internet-based method for dividing personal property items among two or more members of an estate by merging individual estate members? numerical and explicitly non-financial rankings of all items in the estate?s inventory.

(71) Applicants: Ron Witte, Cambridge, MA (US); Ben Cerjan, Houston, TX (US)

(72) Inventors: Ron Witte, Cambridge, MA (US); Ben Cerjan, Houston, TX (US)

(21) Appl. No.: 16/913,599

(22) Filed: Jun. 26, 2020

(51) Int. Cl. G06N 5/04

(52) U.S. Cl. CPC G06N 5/04

(57) ABSTRACT

An internet-based method for mathematically optimizing the distribution of an estate's idiosyncratically (non-financially) valued personal property items among two or more estate members. The method is predicated on the automated merger of independent and strictly numerical rankings of every item in an estate inventory as provided by every estate beneficiary. The method explicitly avoids financial valuation. The result is the distribution of all items in the estate inventory to all parties in the estate according to rules that optimize a correlation between an estate member's strictly numerically ranked interest in an estate item with the likelihood that said estate member will receive said estate item.

### SECTION: CROSS-REFERENCE TO RELATED APPLICATIONS

Not applicable.

### SECTION: FEDERALLY SPONSORED RESEARCH

Not applicable.

### SECTION: SEQUENCE LISTING OR PROGRAM

Not applicable.

### SECTION: TECHNICAL FIELD/FIELD OF THE INVENTION

This embodiment of the techniques set forth in the disclosure relates to the distribution of personal property items in an estate across all members of said estate. In economics literature, the problem being addressed is referred to as “equitable (sometimes ‘fair’) distribution of indivisible goods.”

### SECTION: BACKGROUND—DISCUSSION OF PRIOR ART

The distribution of personal property items in an estate has long been a fraught undertaking. Invariably, this is because the process involves decisions about the significance of specific items, decisions in which an item's subjective or personal value (referred to here as its ‘idiosyncratic value’) is more important than its financial value. Consequentially, the vagaries of personal property distribution processes consistently lead to one of two scenarios: informal/random forms of distribution or simulations of financial value. Regarding informal/random methods, one might think of family members drawing names of items out of a hat, for example. Concerning financial simulations, distributions can be predicated on ‘auctions’ or ‘bidding’ in ways that ascribe financial value to specific items.

Problems invariably arise in either of these scenarios. Random distributions do little to assure that a distribution will be fair. In mathematical terms, it is altogether plausible that a given member of an estate will either have ‘good luck’ or ‘bad luck’, a circumstance that very often leads to acrimonious social relations. Auction/bidding models, meanwhile, add both complexity and uncertainty to the process. Auction/bidding models require subjective financial appraisals that, in turn, must be merged with idiosyncratic values, an ambiguous process prone to increasing inaccuracies and unpredictability in valuation that also leads to social acrimony.

Random and auction/bidding methods ineffectively override the two most important and linked determinants regarding the distribution of estate property items: relative valuation and idiosyncratic valuation. The relative value of a given item has two parts: 1) an item can have a value that is differentiable relative to other items in an estate and 2) an item can have a value for one member of an estate that can be different from its value for another member of that estate. Meanwhile, an item's idiosyncratic value can be determined by only one person: the person who might receive that item. Idiosyncratic values depend on associations and significances regarding estate items that are unique to the beholder. It does not matter what an item's financial value might be. It does not matter why an estate member might want an item. It only matters that he or she does want it. Furthermore, only that person can establish how much he or she wants a given item relative to other items. Finally, as stated above, relative value and idiosyncratic value are intrinsically tied to one another; every member of an estate will have idiosyncratic interests regarding every item across the entire inventory of a given estate.

The use of random or auction/bidding methods for the distribution of idiosyncratically valued items in an estate does little to eliminate the intractable problem of highly variable personal desires regarding said items, a problem that often leads to animosity among family members and acquaintances. The distribution of personal estate property items has remained fraught for as long as property has been the subject of estate division, which is to say, for as long as people have owned things.

The core of this intractable problem lies in the fact that different members in an estate value specific property items using altogether different and subjective criteria (‘idiosyncratic’ criteria). In the case of estate property, such criteria are unusually resilient to definition. Furthermore, such criteria are extremely difficult to correlate across members of an estate and across the usually numerous contents of an estate.

### SECTION: REFERENCES TO RELATED DOCUMENTS

US Patents:
U.S. Pat. No. 8,812,389 “System and method of listing and dividing assets between two or more parties.”
U.S. Pat. No. 9,835,797 “Estate disposition modeling.”
U.S. Pat. No. 9,613,376 “Apparatus and method for recipient distribution and tracking.”

Non-Patent Literature Documents:
Caragiannis, Kurokawa, Moulin, Procaccia, Shah, and Wang. “The Unreasonable Fairness of Maximum Nash Welfare.” ACM Transactions on Economics and Computation, 12, 2019.
Barman, Krishnamurthy, and Vaish. “Finding Fair and Efficient Allocations.” Proceedings of the ACM Conference on Economics and Computation, 2018.

### SECTION: SUMMARY

The process set forth in the disclosure pertains to an internet-based method for optimizing the distribution of an estate's idiosyncratically valued personal property items (‘Estate Inventory’) among two or more estate members (‘Estate Membership’) using a non-financial ranking system. The method is predicated on the automated and mathematically determined merger (‘Rankings Merger’) of independent numerical rankings (‘Independent Rankings’) of every item (‘Estate Item’) in an Estate Inventory as provided by every estate beneficiary (‘Estate Member’). Estate Members use no means other than simple numerical ranking to express their interest in all estate items. The method explicitly avoids financial valuation. The result is a distribution (‘Final Merged Distribution’) of all items in the Estate Inventory to all parties in the Estate Membership according to rules that optimize a correlation between an Estate Member's numerically ranked interest in an Estate Item with the likelihood that said Estate Member will receive said Estate Item.

The method is structured around five modules: an Estate Membership Module; an Estate Inventory Module; an Aggregate Rankings Module; a Rankings Merger Module; and a Results Module.
1) Estate Membership Module: The Estate Membership Module is for adding and administering individual Estate Members. See FIG. 1, Reference 1. See also FIG. 2.
2) Estate Inventory Module: The Estate Inventory Module is for adding and administering individual Estate Items using an image-based drag-and-drop data management method. See FIG. 1, Reference 2. See also FIG. 3.
3) Aggregate Rankings Module: The Aggregate Rankings Module enables each Estate Member to independently numerically rank every Estate Item in the Estate Inventory using a drag-and-drop ranking interface and, once complete, to send said Estate Member's Independent Ranking to the Rankings Merger Module. See FIG. 1, Reference 3. See also FIG. 4.
4) Rankings Merger Module: The Rankings Merger Module mathematically merges all Independent Rankings into a single distribution that correlates an Estate Member's numerically based Independent Rankings with the likelihood of said Estate Member receiving specific Estate Items. The Rankings Merger Module also self-corrects for ties as Independent Rankings are merged, assuring that no Estate Member is disadvantaged by the process. See FIG. 1, Reference 4.
5) Results Module: The Results Module provides an interface for viewing the exported results of the Rankings Merger Module. See FIG. 1, Reference 5. See also FIG. 5.

### SECTION: REFERENCE TO DRAWINGS

FIG. 1: Overview flow diagram illustrating relationships among the Estate Membership Module, Estate Inventory Module, Independent Rankings Module, Rankings Merger Module, and Results Module.

### Additional Illustrations:

FIG. 2 illustrates the Estate Membership Module online user interface.

FIG. 3 illustrates the Estate Inventory Module online user interface.

FIG. 4 illustrates the Aggregate Rankings Module online user interface.

FIG. 5 illustrates the Results Module online user interface.

### SECTION: REFERENCE NUMERALS

1: Estate Membership Module
1a: Estate Membership Input Module—User
1b: Estate Membership Management Module—Server
1c: Estate Membership—User-Server communication
2: Estate Inventory Module
2a: Estate Inventory Input Module—User—Drag-and-Drop Image-based Interface
2b: Estate Inventory Management Module—Server
2c: Estate Inventory—User-Server communication
3: Aggregate Rankings Module
3a: Estate Member “a”
3a.1: Estate Member “a” Independent Ranking Module pairing with Estate Inventory—Server
3a.2: Estate Member “a” Independent Ranking Module—User—Drag-and-Drop Image-based Interface
3a.3: Estate Member “a”—User-Server communication for Independent Ranking Module and submittal
3b: Estate Member “b”
3b.1: Estate Member “b” Independent Ranking Module pairing with Estate Inventory—Server
3b.2: Estate Member “b” Independent Ranking Module—User—Drag-and-Drop Image-based Interface
3b.3: Estate Member “b”—User-Server communication for Independent Ranking Module and submittal
3c: Estate Member “c”
3c.1: Estate Member “c” Independent Ranking Module pairing with Estate Inventory—Server
3c.2: Estate Member “c” Independent Ranking Module—User—Drag-and-Drop Image-based Interface
3c.3: Estate Member “c”—User-Server communication for Independent Ranking Module and submittal
3x: Estate Member “x”—“x” is a variable indicating the total estate membership number is dynamic.
3x.1: Estate Member “x” Independent Ranking Module pairing with Estate Inventory—Server
3x.2: Estate Member “x” Independent Ranking Module—User—Drag-and-Drop Image-based Interface
3x.3: Estate Member “x”—User-Server communication for Independent Ranking Module and submittal
3z: Dynamic range of Estate Members in a given Estate Membership
4: Rankings Merger Module—Server
5: Results Module—User-Server communication—Image-Based
6: Pairing of each Estate Member with Estate Inventory
6a: Routing of Estate Member “a” pairing
6b: Routing of Estate Member “b” pairing
6c: Routing of Estate Member “c” pairing
6x: Routing of Estate Member “x” pairing
7: Routing of finalized Independent Rankings output to Rankings Merger Module
7a: Routing of Member “a” finalized Independent Rankings output to Rankings Merger Module
7b: Routing of Member “b” finalized Independent Rankings output to Rankings Merger Module
7c: Routing of Member “c” finalized Independent Rankings output to Rankings Merger Module
7x: Routing of Member “x” finalized Independent Rankings output to Rankings Merger Module
8: Export routing of Final Merged Distribution data to Results Module

### SECTION: DETAILED DESCRIPTION AND OPERATION—FIRST EMBODIMENT

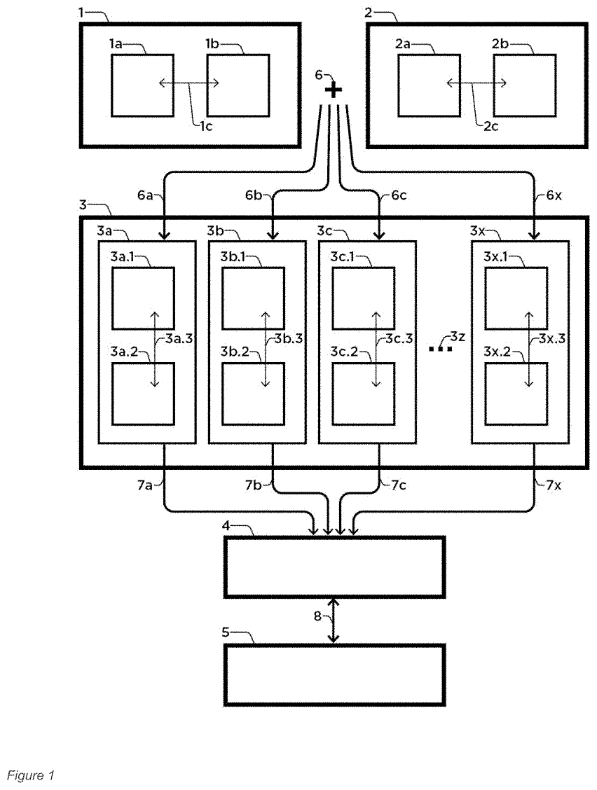

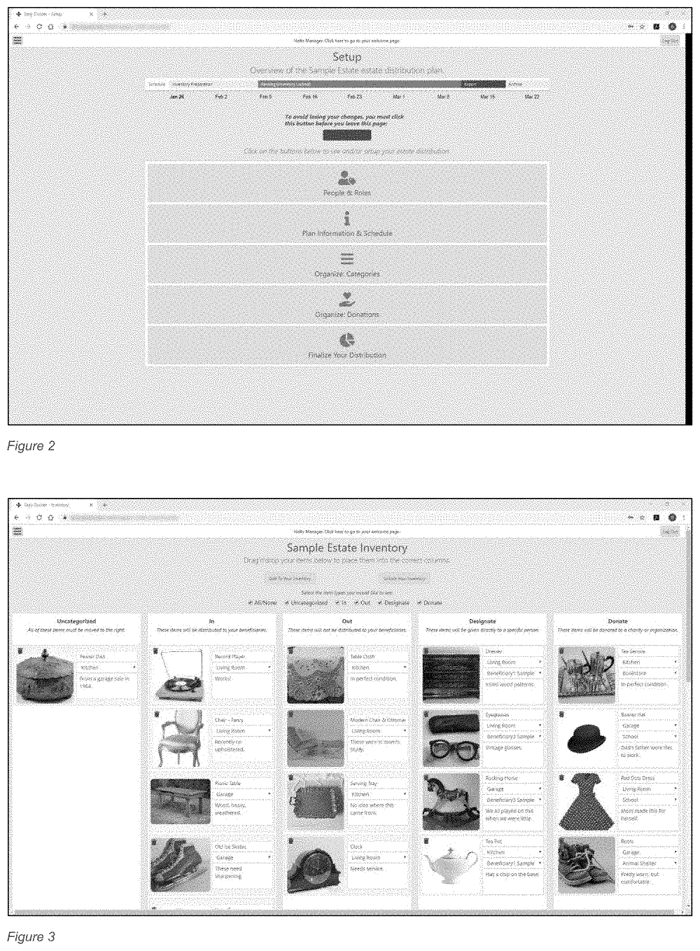

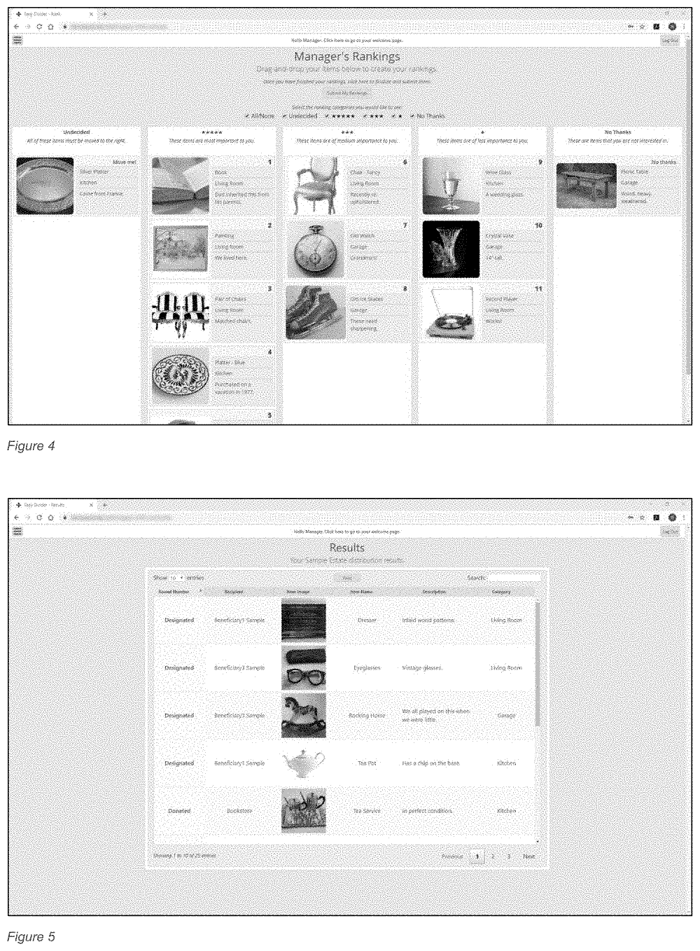

Note: All references are to FIG. 1.

FIG. 1 shows a process for distributing an Estate Inventory containing Estate Items of idiosyncratic value to all Estate Members in an Estate Membership comprising an Estate Membership Module 1; an Estate Inventory Module 2; an Aggregate Rankings Module 3; a Rankings Merger Module 4; and a Results Module 5.

Estate Membership Module 1 has two sub-modules: Estate Membership Input Module 1a and Estate Membership Management Module 1b. Estate Membership Input Module 1a is comprised of a User's computer input device capable of entering data, displaying said data, submitting said data to the Server, receiving said data from the Server, and computer code to enable the administration, access to, and storage of Estate Membership data. Module 1a is paired and communicates with the Estate Membership Management Module 1b, comprised of an internet-based data Server and computer code to enable the administration, access to, and storage of Estate Membership data. Modules 1a and 1b communicate across the internet via data transfer route 1c.

Estate Inventory Module 2 has two sub-modules: Estate Inventory Input Module 2a and Estate Inventory Management Module 2b. The Estate Inventory Input Module 2a is comprised of a User's computer input device capable of entering data, displaying said data, submitting said data to the Server, receiving said data from the Server, and computer code to enable the administration, access to, and storage of Estate Inventory data. Module 2a is paired with The Estate Inventory Management Module 2b, comprised of an internet-based data Server and computer code to enable the administration, access to, and storage of Estate Inventory data. Modules 2a and 2b communicate across the internet via data transfer route 2c.

Aggregate Rankings Module 3 has sub-modules for each Estate Member, comprising a pairing of a copy of the Estate Inventory exclusive to said Estate Member —3a.1, 3b.1, 3c.1, 3x.1—with an Independent Ranking Module that is exclusive to said Estate Member —3a.2, 3b.2, 3c.2, 3x.2. The exclusive Estate Inventories—3a.1, 3b.1, 3c.1, 3x.1—are located on an internet-based data Server and are comprised of computer code to enable the administration, access to, and storage of the Estate Members' independent Estate Inventory data. The exclusive Independent Ranking Modules—3a.2, 3b.2, 3c.2, 3x.2—are comprised of Users' computer input devices capable of entering data, displaying said data, submitting said data to the Server, receiving said data from the Server, and computer code to enable the administration, access to, and storage of Independent Rankings Module data. 3a.1, 3b.1, 3c.1, 3x.1 and 3a.2, 3b.2, 3c.2, 3x.2 communicate across the internet via data transfer routes 3a.3, 3b.3, 3c.3, 3x.3.

Rankings Merger Module 4 is located on an internet-based data Server and is comprised of computer code designed to receive and merge two or more Independent Rankings from the Aggregate Rankings Module 3, the results of which are exported as the Final Merged Distribution. Independent Rankings are communicated to the Rankings Merger Module 4 on an internet-based server via data transfer routes 7a, 7b, 7c, and 7x.

Results Module 5 displays, filters, and exports the Final Merged Distribution results received from of Ranking Merger Module 4. Results Module 5 is comprised of a User's computer input device capable of entering data, displaying said data, submitting said data to the Server, receiving said data from the Server, and computer code to enable the administration, access to, and storage of Results data. The Final Merged Distribution results from the Ranking Merger Module 4 are communicated to the Results Module 5 across the internet via data transfer route 8.

### SECTION: CONCLUSION, RAMIFICATIONS, AND SCOPE

The embodiment of the techniques set forth in the disclosure enables the distribution of all items in an estate inventory to all parties in the estate according to rules that optimize a correlation between an estate member's numerically ranked interest in an estate Item with the likelihood that said estate member will receive said estate item. The method explicitly avoids financial valuation.

Tightly integrated tools enable the administration of estate membership, inventory, individual item ranking, and merging of individual rankings into a single master distribution list, thereby significantly improve on existing methods for estate property distribution. The method is more equitable, saves time, eliminates travel requirements, is more cost effective, is easier to use, and most important, is beneficial to the social compassions that are particularly important at precisely the moment that estate distributions take place.

1. A method for distributing idiosyncratically valued Estate Items in an Estate Inventory to all Estate Members in an Estate Membership using numerical rankings and without the use of any form of financial valuation, wherein the improvement comprises:
a. creating an Estate Membership catalog comprising all Estate Members by pairing an Estate Membership Module and an Estate Membership Management Module, and
b. creating an image-based Estate Inventory comprising all Estate Items in said Estate Inventory by pairing an Estate Inventory Module and an Estate Inventory Management Module using an image-based drag-and-drop sorting interface, and
c. pairing said Estate Inventory independently with each Estate Member of said Estate Membership, and
d. creating an Independent Ranking Module enabling each Estate Member of said Estate Membership to independently numerically rank every Estate Item in said Estate Inventory using only an image-based drag-and-and-drop ranking interface without the need for any financial valuation, and
e. transmitting each Estate Member's Independent Ranking to the Rankings Merger Module, and
f. merging mathematically all Estate Members' Independent Rankings into a single Final Merged Distribution so as to give any specific Estate Item to that Estate Member who has ranked said Estate Item highest and, in the event of a tie, compensating an Estate Member who did not receive his or her earlier/higher-choice item so as to give him or her a higher (tie-breaking) ranking,
whereby the Final Merged Distribution of all items in the Estate Inventory to all Estate Members in the Estate Membership will mathematically optimize the correlation between a specific Estate Member's self-generated ranking of an Estate Item with the likelihood that said Estate Member will receive said Estate Item.
